(19) United States
(12) Patent Application Publication
(10) Pub. No.: US 2025/0173758 A1
(43) Pub. Date: May 29, 2025

(54) COMMERCIAL INTENT DETECTION AND KEYWORD EXTRACTION

(71) Applicant: Snap Inc., Santa Monica, CA (US)

(72) Inventors: Sepideh Azarnoosh, Lake Forest, CA (US); Jason Brewer, Mountain View, CA (US); Lyn Chen, Irvine, CA (US); Xueyin Chen, Los Angeles, CA (US); Shuo Han, Milpitas, CA (US); Mehrdad Jahangiri, Sherman Oaks, CA (US); Nima Khajehnouri, Santa Monica, CA (US); Weihan Li, Santa Clara, CA (US); Sheng Xu, Los Angeles, CA (US); Haoruo Yan, Los Angeles, CA (US)

(21) Appl. No.: 18/523,554

(22) Filed: Nov. 29, 2023

(51) Int. Cl. G06Q 30/0251; G06F 40/30; H04L 51/02

(52) U.S. Cl. CPC G06Q 30/0256; G06F 40/30; H04L 51/02

(57) ABSTRACT

A chatbot system detects commercial intent during conversations with users and provides targeted advertisements. The chatbot system extracts keyword candidates from a conversation and assigns relevance scores based on the meaning of the conversation and commercial scores based on a machine learning model trained to detect commercially-related keywords. The chatbot system selects keywords based on a combination of the scores and transmits the selected keywords to advertising content servers that provide advertising content including advertisements selected using the keywords. The chatbot system displays the advertisements to the user during the conversation. The chatbot system may integrate the advertisements into the chatbot's responses, select advertisements based on a predicted click-through rate for the user, train the machine learning model using translations of labeled examples, access a long-term memory of the user's conversations and user profile data to provide context for the advertisements, and analyze messages from multiple users in group chats.

### TECHNICAL FIELD

The present disclosure relates generally to interactive platforms and more particularly to providing interaction interfaces to users of an interactive platform.

### BACKGROUND

Users access chatbots to provide useful information. In some conversations, a user may seek information on products or services that the user is interested in.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a messaging system, according to some examples, that has both client-side and server-side functionality.

FIG. 3A is a block diagram of a chatbot system in accordance with some examples.

FIG. 3B illustrates a process of providing advertising content during a chatbot conversation, in accordance with some examples.

FIG. 4A illustrates a machine-learning pipeline, according to some examples.

FIG. 4B illustrates training and use of a machine-learning program, according to some examples.

FIG. 5 illustrates a compliance system, in accordance with some embodiments.

FIG. 6 is a diagrammatic representation of a data structure as maintained in a database, according to some examples.

FIG. 7 is a diagrammatic representation of a message, according to some examples.

FIG. 8 is a diagrammatic representation of a machine in the form of a computer system within which a set of instructions may be executed to cause the machine to perform any one or more of the methodologies discussed herein, according to some examples.

FIG. 9 is a block diagram showing a software architecture within which examples may be implemented.

### DETAILED DESCRIPTION

Interactive platforms (e.g., social platforms, social media platforms, interaction systems, AR platforms, applications, messaging platforms, AR applications, operating systems, gaming systems or applications, systems with which a user interacts, and the like) may provide a way for users to access information about products or services. For some users, interaction with an interactive platform may be enhanced by interacting with a chatbot software application designed to simulate human conversation through voice commands or text chats. A chatbot system may employ Natural Language Processing (NLP) and Machine Learning (ML)/artificial intelligence methodologies to understand and interpret a user's input and generate a response. A chatbot can serve multiple uses during a conversation including providing useful information to a user.

Methodologies described herein provide an enhanced, personalized user experience with chatbots and other conversational systems. In some examples, a chatbot system detects commercial intent during conversations with one or more users and provides targeted advertisements within a context of the conversation. The chatbot system extracts keyword candidates from the conversation and assigns relevance scores using the meaning of the conversation and commercial scores using a Machine Learning (ML) model trained to detect commercially-related keywords. The chatbot system selects keywords using a combination of the commercial score and the relevance score and transmits the selected keywords to advertising content servers. The advertising content servers provide advertising content comprising one or more advertisements selected using the keywords. The chatbot system provides the advertisements to the one or more users during the conversation.

In some examples, a chatbot system detects commercial intent in a conversation between a user and a chatbot using a ML model trained on examples of commercially-related and non-commercially-related conversations. If commercial intent is detected, the chatbot system extracts keyword candidates from the conversation, such as noun phrases and verb phrases referring to products, services, or user needs. The chatbot system assigns a relevance score to each keyword candidate based on how well it represents the meaning and topic of the conversation. In some examples, the chatbot system assigns a commercial score to each keyword candidate using a ML model trained on examples of commercially-related keywords.

In some examples, the chatbot system selects one or more keywords using a combination of the relevance scores and commercial scores. In some examples, the chatbot system multiplies the relevance and commercial scores to obtain a combined score for each keyword and selects the keywords with the highest combined scores. The selected keywords are transmitted to one or more advertising content servers, that return advertising content comprising advertisements selected using the keywords. The advertisements may be for products, services, or content related to the keywords.

The chatbot system displays the advertisements to the user during the conversation with the chatbot. In some examples, the chatbot system integrates the advertisements into the chatbot's responses to provide a cohesive user experience. In some examples, the chatbot system may select particular advertisements using a predicted click-through rate or other engagement metric for the specific user.

In some examples, the machine learning models used by the chatbot system are trained on data comprising translations of labeled examples from a first language into a second language.

In some examples, the chatbot system may access a long-term memory of the user's conversations and user profile data to provide additional context for assigning commercial scores to keyword candidates. The long-term memory and profile data indicate the user's interests, needs, and commercial preferences.

In some examples, the conversation comprises a group chat, and the chatbot system analyzes messages from multiple users in the group chat to detect commercial intent and extract keyword candidates while respecting user privacy.

In some examples, a chatbot system detects a commercial intent during a conversation between a user and a chatbot. In response, the chatbot system extracts keyword candidates from the conversation, assigns relevance scores and commercial scores to the keyword candidates using machine learning models, selects keywords using the scores, transmits the selected keywords to advertising content servers, receives advertisements from the advertising content servers using the keywords, and provides the advertisements to the user during the conversation.

In some examples, the chatbot system integrates the advertisements into responses from the chatbot.

In some examples, the chatbot system selects the advertisements further using a predicted click-through rate for the user.

In some examples, the chatbot system trains the machine learning model on data comprising translations of labeled examples from a first language into a second language.

In some examples, the chatbot system accesses a long-term memory of the user's conversations to provide contextual information for assigning the commercial scores.

In some examples, the chatbot system accesses user profile data to provide contextual information for assigning the commercial scores.

In some examples, the chatbot system analyzes messages from multiple users in a group chat conversation while respecting user privacy.

Other technical features may be readily apparent to one skilled in the art from the following figures, descriptions, and claims.

### Networked Computing Environment

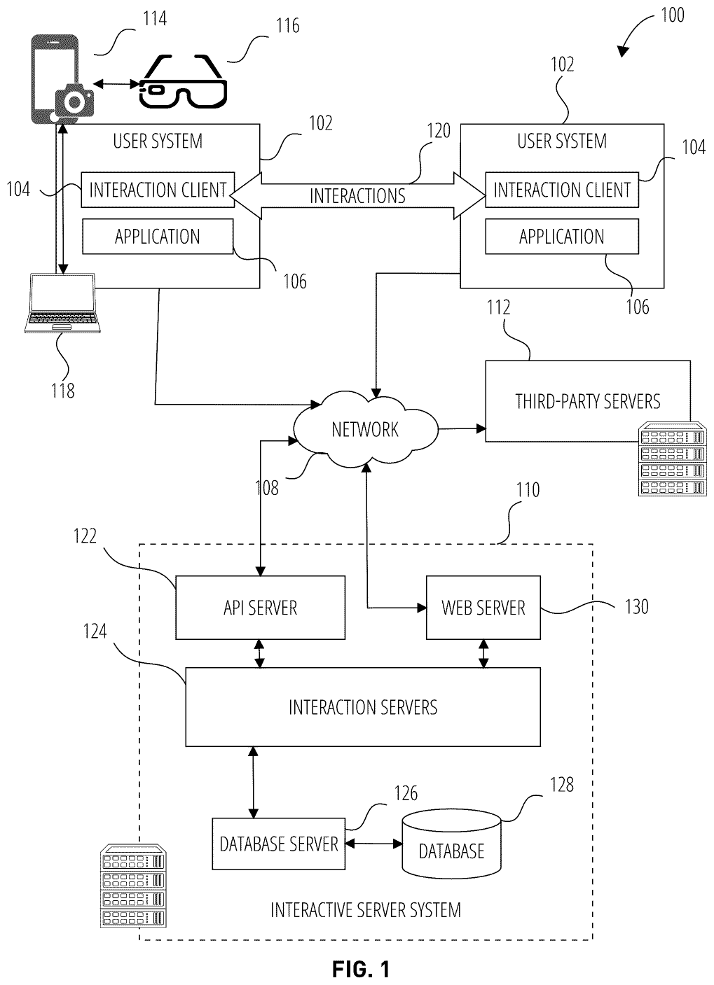

FIG. 1 is a block diagram showing an example interactive platform 100 for facilitating interactions (e.g., exchanging text messages, conducting text audio and video calls, or playing games) over a network. The interactive platform 100 includes multiple client systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other client systems 102), an interactive server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interactive server system 110 via the network 108. The data exchanged between the interaction clients 104 (e.g., interactions 120) and between the interaction clients 104 and the interactive server system 110 includes functions (e.g., commands to invoke functions) and payload data (e.g., text, audio, video, or other multimedia data).

The interactive server system 110 provides server-side functionality via the network 108 to the interaction clients 104. While certain functions of the interactive platform 100 are described herein as being performed by either an interaction client 104 or by the interactive server system 110, the location of certain functionality either within the interaction client 104 or the interactive server system 110 may be a design choice. For example, it may be technically preferable to initially deploy particular technology and functionality within the interactive server system 110 but to later migrate this technology and functionality to the interaction client 104 where a user system 102 has sufficient processing capacity.

The interactive server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, interactive platform information, and live event information. Data exchanges within the interactive platform 100 are invoked and controlled through functions available via user interfaces (UIs) of the interaction clients 104.

Turning now specifically to the interactive server system 110, an Application Program Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the interaction servers 124 and the client systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity graph (e.g., a social graph); the location of friends within a social graph; and opening an application event (e.g., relating to the interaction client 104).

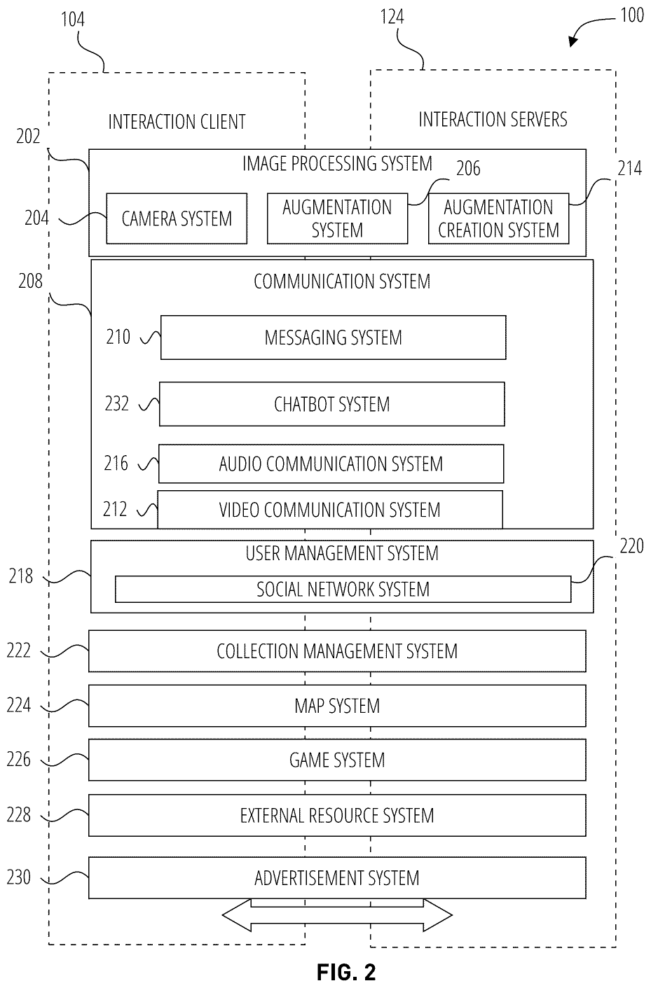

The interaction servers 124 host multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally-installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally-installed application 106, the interaction client 104 instructs the user system 102 to launch the external resource by executing locally-stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, using a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

### System Architecture

FIG. 2 is a block diagram illustrating further details regarding the interactive platform 100, according to some examples. Specifically, the interactive platform 100 is shown to comprise the interaction client 104 and the interaction servers 124. The interactive platform 100 embodies multiple subsystems, which are supported on the client-side by the interaction client 104 and on the server-side by the interaction servers 124. Example subsystems are discussed below.

An image processing system 202 provides various functions that enable a user to capture and augment (e.g., augment or otherwise modify or edit) media content associated with a message.

A camera system 204 includes control software (e.g., in a camera application) that interacts with and controls hardware camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory of a user system 102. These augmentations are selected by the augmentation system 206 and presented to a user of an interaction client 104, using a number of inputs and data, such as for example:
geolocation of the user system 102; and
interactive platform information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interactive platform 100 and includes a messaging system 210, a chatbot system 232, an audio communication system 216, and a video communication system 212. The messaging system 210 is responsible for enforcing the temporary or time-limited access to content by the interaction clients 104. The messaging system 210 incorporates multiple timers within an ephemeral timer system (not shown) that, using duration and display parameters associated with a message or collection of messages (e.g., a story), selectively enable access (e.g., for presentation and display) to messages and associated content via the interaction client 104. Further details regarding the operation of the ephemeral timer system are provided below. The audio communication system 216 enables and supports audio communications (e.g., real-time audio chat) between multiple interaction clients 104. Similarly, the video communication system 212 enables and supports video communications (e.g., real-time video chat) between multiple interaction clients 104. The chatbot system 232 is responsible for generating responses to prompts received from a user and communicating a response to the prompt.

A user management system 218 is operationally responsible for the management of user data and profiles, and includes a social network system 220 that maintains social network information regarding relationships between users of the interactive platform 100.

A collection management system 222 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 222 may also be responsible for publishing an icon that provides notification of a particular collection to the user interface of the interaction client 104. The collection management system 222 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 222 employs machine vision (or image recognition technology) and content rules to curate a content collection automatically. In certain examples, compensation may be paid to a user to include user-generated content into a collection. In such cases, the collection management system 222 operates to automatically make payments to such users to use their content.

A map system 224 provides various geographic location functions and supports the presentation of map-based media content and messages by the interaction client 104. For example, the map system 224 enables the display of user icons or avatars (e.g., stored in profile data 602) on a map to indicate a current or past location of “friends” of a user, as well as media content (e.g., collections of messages including photographs and videos) generated by such friends, within the context of a map. For example, a message posted by a user to the interactive platform 100 from a specific geographic location may be displayed within the context of a map at that particular location to “friends” of a specific user on a map interface of the interaction client 104. A user can furthermore share his or her location and status information (e.g., using an appropriate status avatar) with other users of the interactive platform 100 via the interaction client 104, with this location and status information being similarly displayed within the context of a map interface of the interaction client 104 to selected users.

A game system 226 provides various gaming functions within the context of the interaction client 104. The interaction client 104 provides a game interface providing a list of available games that can be launched by a user within the context of the interaction client 104 and played with other users of the interactive platform 100. The interactive platform 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 228 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interactive server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A WebViewJavaScriptBridge running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 230 operationally enables the purchasing of advertisements by third parties for presentation to end-users via the interaction clients 104 and also handles the delivery and presentation of these advertisements.

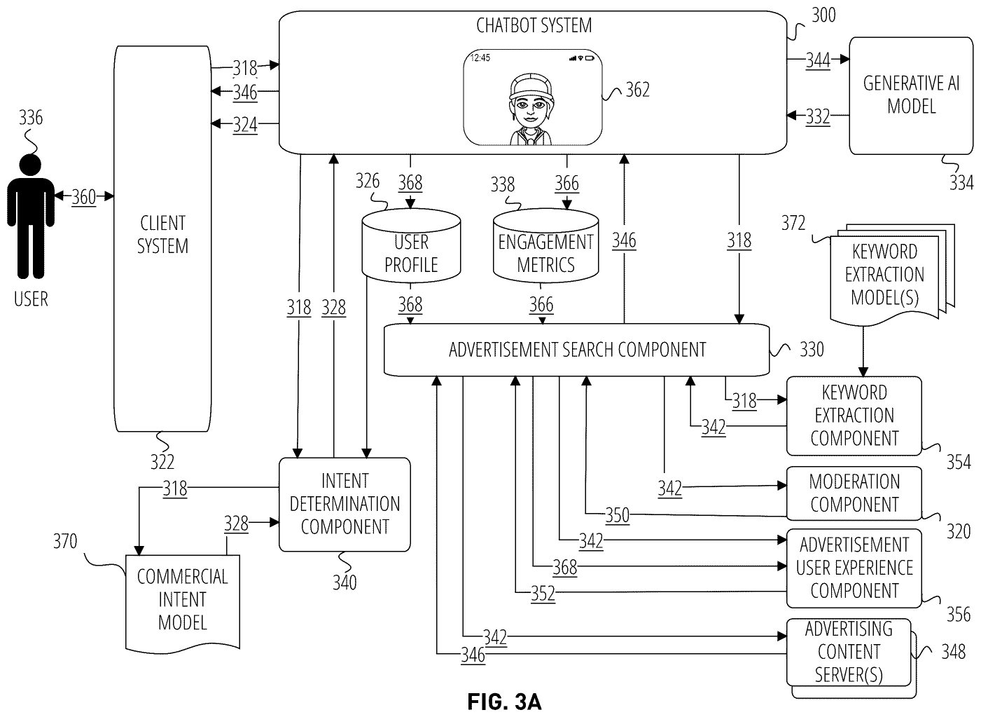

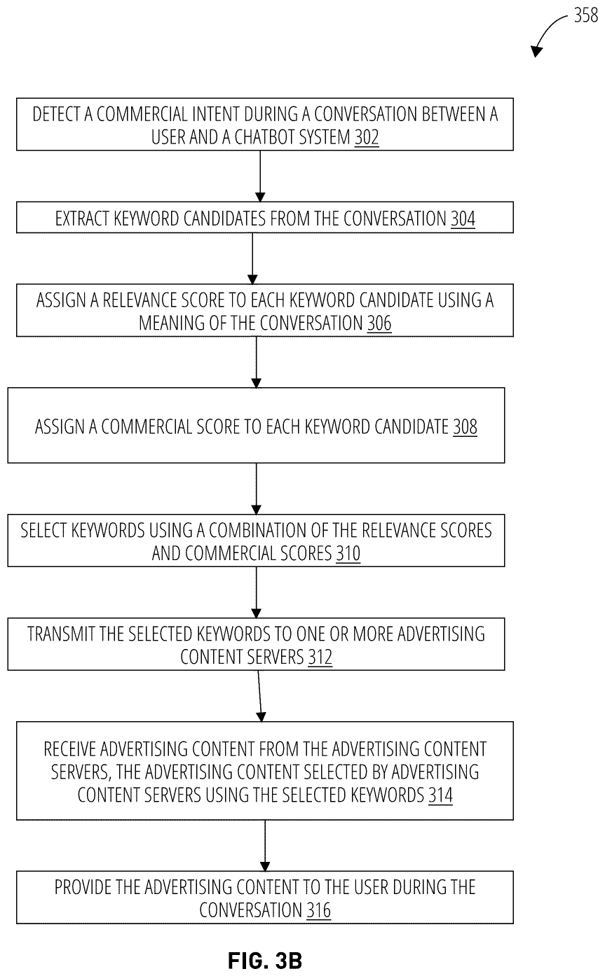

FIG. 3A is an illustration of a chatbot system 300 and FIG. 3B is a process flow diagram of an embedded advertisement method 358 that embeds advertisements in a conversation 360 between a user 336 and a chatbot 362 of the chatbot system 300, in accordance with some examples.

Although the example embedded advertisement method 358 depicts a particular sequence of operations, the sequence may be altered without departing from the scope of the present disclosure. For example, some of the operations depicted may be performed in parallel or in a different sequence that does not materially affect the function of the chatbot system 300. In other examples, different components of an example device or system that implements the chatbot system 300 may perform functions at substantially the same time or in a specific sequence.

In some examples, the chatbot system 300 is a software platform designed to simulate human conversation through voice commands or text chats. The chatbot system 300 employs natural language processing (NLP) and machine learning (ML)/artificial intelligence methodologies to understand and interpret user messages 318 of the user 336 and generate chatbot messages 324 during a conversation 360.

In some examples, the chatbot system 300 receives user messages 318 from the user 336 via a client system 322 during a conversation 360 that the user 336 is having with the chatbot 362 of the chatbot system 300. The chatbot system 300 receives the user messages 318 and generates questions or prompts 344 for one or more generative Artificial Intelligence (AI) models, such as generative AI model 334. The generative AI model 334 receives the prompts 344 and generates responses 332 using the prompts 344. The generative AI model 334 communicates the responses 332 to the chatbot system 300. The chatbot system 300 receives the responses 332 and generates chatbot messages 324 using the responses 332. The chatbot system 300 communicates the chatbot messages 324 to the user 336 via the client system 322 during the conversation 360.

In some examples, the user messages 318 may include other types of data as well as text data such as, but not limited to, image data, video data, audio data, electronic documents, links to data stored on the Internet or the client system 322, and the like. In addition, the user messages user messages 318 may include media such as, but not limited to, audio media, image media, video media, textual media, and the like. Regardless of the data type of the user messages 318, keyword attribution and expansion may be used to automatically generate a cluster of keywords or attributes that are associated with the received user message 318. For example, image recognition may be deployed to identify objects and location associated with visual media and image data and to generate a keyword cluster or cloud that is then associated with the image-based prompt.

The user messages 318 may furthermore be received through any number of interfaces and I/O components of a client system 322. These include gesture-based inputs obtained from a biometric component and inputs received via a Brain-Computer Interface (BCI).

In some examples, the chatbot system 300 is integrated into various platforms such as, but not limited to, websites, messaging apps, and mobile apps, allowing users to interact with the chatbot 362 through text or voice commands.

In operation 302, the chatbot system 300 detects a commercial intent 328 during a conversation 360 between a user 336 and a chatbot provided by the chatbot system 300. For example, the chatbot system 300 uses an intent determination component 340 to detect commercial intent during conversations between users and the chatbot. Commercial intent refers to a user's interest in or need for a commercial product, service, or content. The intent determination component 340 detects commercial intent by analyzing the text of user messages 318 in the conversation 360 between the user 336 and the chatbot 362 to determine whether the user has expressed an interest in acquiring or learning something about a product or service through an advertisement.

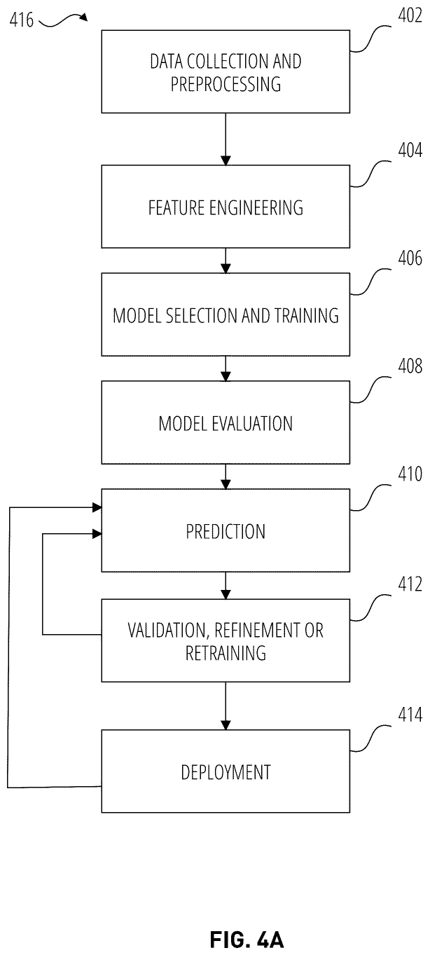

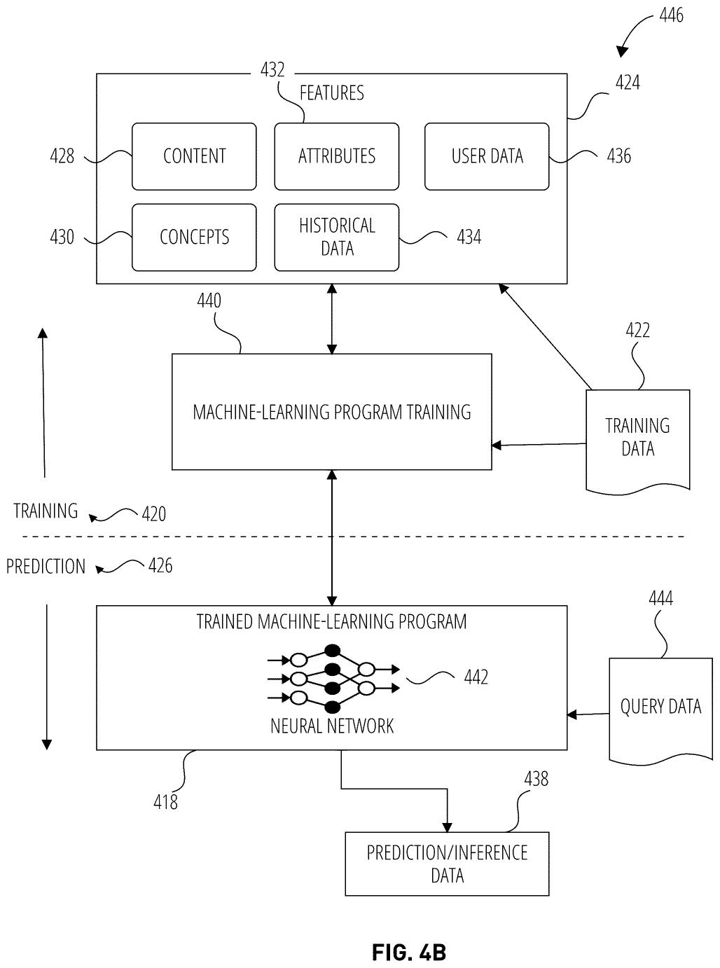

In some examples, the intent determination component 340 uses a commercial intent model 370 trained on examples of conversations with and without commercial intent to detect commercial intent as more fully described in reference to FIG. 4A and FIG. 4B. The commercial intent model 370 is trained on conversations labeled by human annotators as having or not having commercial intent. In some examples, the commercial intent model 370 is a neural network that generates embeddings for conversations which are then used to classify commercial intent 328. In some examples, the commercial intent model 370 is a binary classifier that determines whether a conversation expresses commercial intent or not.

The intent determination component 340 passes the text of the user messages 318 during the conversation 360 to the commercial intent model 370, which returns a prediction of whether the user messages 318 of the conversation 360 expresses a commercial intent 328 or not.

Detecting commercial intent 328 allows the chatbot system 300 to determine when advertisements are appropriate and relevant to the needs and interests of the user 336. By analyzing conversations for commercial intent 328 before providing advertisements in advertising content 346 to the user 336, the chatbot system 300 avoids providing generic or untargeted advertisements that may detract from the user experience. The use of a commercial intent model 370 enables the chatbot system 300 to gain a nuanced understanding of user intent from natural language conversations.

In response to determining that the user messages 318 comprise a commercial intent 328, the chatbot system 300 uses an advertisement search component 330 to determine advertising content 346 using the user messages 318.

In operation 304, the advertisement search component 330 extracts keyword candidates from the conversation 360. For example, the advertisement search component 330 uses an advertisement search component 330 to extract keywords 342 from the user messages 318. The keyword extraction component 354 extracts keyword candidates from the user messages 318 of the conversation 360 by identifying phrases in the user message 318 that refer to products, services, brands, user needs, or other commercial topics. The keyword candidates represent concepts and topics that could be used to select targeted advertisements included in the advertising content 346.

In some examples, the keyword extraction component 354 extracts keyword candidates using natural language processing techniques such as:
Part-of-speech tagging: Identifying the syntactic category of words in the conversation, such as nouns, verbs, adjectives, and adverbs. The keyword extraction component 354 focuses on extracting noun phrases and verb phrases as keyword candidates.
Chunking: Grouping words into syntactically correlated phrases. The keyword extraction component 354 chunks the conversation into noun phrases, verb phrases, and other phrases that could refer to commercial offerings or user needs.
Named entity recognition: Identifying references to named entities such as products, services, companies, locations, dates, and more. The keyword extraction component 354 extracts named entities referring to products, services, brands, and businesses as keyword candidates.
Stopword removal: Filtering out common words such as “the”, “a”, and “to” that have little semantic meaning. The keyword extraction component 354 removes stopwords to isolate meaningful phrases as keyword candidates.
Lemmatization: Reducing related words to their base form. For example, the words “fishing”, “fished”, and “fisher” would be reduced to “fish”. Lemmatization allows the keyword extraction component 354 to group related phrases.
Frequency analysis: Identifying phrases that appear frequently in the conversation, which often represent key topics or subjects of discussion. The keyword extraction component 354 favors more frequently occurring phrases as keyword candidates.

In some examples, the keyword extraction component 354 uses a hybrid approach combining statistical techniques like frequency analysis with one or more keyword extraction model 372 that can analyze semantic relationships, contexts, and word associations in the conversation. The training and deployment of the one or more keyword extraction model 372 are more fully described in reference to FIG. 4A and FIG. 4B. The keyword candidate extraction techniques result in a set of keyword candidates in the form of phrases representing the essence and commercial aspects of the conversation.

The quality and coverage of the keyword candidates impact the relevance of the selected advertisements. Techniques that can accurately identify a diverse range of product references, service references, and other commercial phrases lead to advertisements tailored to user intent.

In operation 306, the keyword extraction component 354 assigns a relevance score to keyword candidates using a meaning of the conversation 360. For example, the keyword extraction component 354 uses the keyword extraction component 354 to assign a relevance score to keyword candidates using a meaning of the conversation 360. The keyword extraction component 354 assigns a relevance score to a keyword candidate based on how well it represents the overall meaning, subject, or purpose of the conversation 360. Keyword candidates that are more central to the conversation 360 and capture more specific details receive higher relevance scores. The relevance scores indicate how useful a keyword candidate may be for selecting advertising content 346 that aligns with the conversation 360.

In some examples, the keyword extraction component 354 determines relevance scores using statistical metrics such as:
Term frequency-inverse document frequency (TF-IDF): A metric that measures how important a phrase is to a conversation. Keyword candidates that appear frequently in the conversation but rarely in other conversations receive higher TF-IDF scores. The scores reflect how uniquely relevant a keyword candidate is to the conversation.
Contextual similarity: Measuring how similar a keyword candidate is to its surrounding context in the conversation. Keyword candidates that frequently appear near other keyword candidates or in similar contexts receive higher contextual similarity scores. The scores indicate semantic relationships between keyword candidates.
Keyphraseness: Determining how much a keyword candidate resembles a keyphrase that is central to the meaning of the conversation. Keyword candidates that capture more specific details and represent the core subject or purpose of the conversation receive higher keyphraseness scores. The scores identify keyword candidates that are most salient to the conversation.
Embeddings: The keyword extraction component 354 generates vector representations of the conversation and each keyword candidate that encode their semantic meaning. Keyword candidates with embeddings more similar to the conversation embedding receive higher relevance scores. The scores reflect semantic relevance.
Attention: The keyword extraction component 354 applies attention mechanisms to determine which parts of the conversation are most relevant to each keyword candidate. Keyword candidates that attend strongly to central or salient parts of the conversation receive higher relevance scores. The scores indicate relevance based on contextual relationships.

The relevance scoring techniques allow the keyword extraction component 354 to evaluate how well each keyword candidate represents the essence and meaning of the conversation 360. Keyword candidates with higher relevance have a stronger connection to the conversation topic and user intent. By selecting keyword candidates using relevance, the system can provide advertising content 346 tailored to what the user wants to discuss or accomplish.

In operation 308, the chatbot system 300 assigns a commercial score to each keyword candidate using a machine learning model trained to detect commercially related keywords. For example, the keyword extraction component 354 assigns a commercial score to each keyword candidate using a machine learning model trained to detect commercially related keywords.

The keyword extraction component 354 assigns a commercial score to a keyword candidate using a machine learning model trained to detect commercially-related keywords. The commercial scores reflect the likelihood of a keyword candidate triggering relevant advertisements of the advertising content 346. In some examples, keyword candidates closely connected to products, services, brands, and other commercial entities receive higher commercial scores.

In some examples, the machine learning model is trained on a dataset of keywords labeled as commercially-related or not. The model learns patterns in the keywords, such as:
References to products, services, brands, businesses, and other commercial entities.
Expressions of needs or interests that could be fulfilled by a commercial offering. For example, “need a new laptop”, “looking for Mexican food”.
Words and phrases commonly used in a commercial context. For example, “buy”, “purchase”, “get”.

In some examples, the model may be a neural network that generates embeddings for keywords which are then used to determine commercial relevance. In some examples, the model is a binary classifier that predicts whether a keyword is commercially-related or not. In some examples, the model is optimized to achieve high accuracy for commercial keyword detection.

In some examples, the keyword extraction component 354 passes keyword candidates to the machine learning model, which returns a commercial score reflecting the likelihood of a keyword candidate relating to a product, service, brand, or other commercial entity. Keyword candidates with a strong connection to commercial offerings receive higher commercial scores. The commercial scores enable the system to evaluate keyword candidates using their potential for targeting the advertising content 346.

In some examples, the performance of the machine learning model impacts relevance of the advertising content 346. A model with high precision accurately identifies keyword candidates suited for commercial advertising content 346 while avoiding false positives. A model with high recall identifies most commercially-relevant keyword candidates, minimizing missed opportunities. In some examples, the model is optimized to balance precision and recall for commercial keyword detection.

In some examples, the commercial scores of keyword candidates, combined with their relevance scores, results in a multi-dimensional analysis of a keyword candidate's usefulness for advertising content 346 targeting. Keyword candidates with high commercial scores and relevance scores represent concepts and topics central to the commercial interests and intent of the user 336.

In operation 310, the keyword extraction component 354 selects keywords using a combination of the relevance scores and commercial scores of a keyword candidate. For example, the keyword extraction component 354 selects keyword candidates as keywords 342 to use for ad targeting by combining the relevance scores and commercial scores assigned to each keyword candidate.

In some examples, the keyword extraction component 354 combines the relevance score and commercial score of a keyword candidate using a weighted sum, where the weights determine the relative importance of each score. For example:

$$combined\_score = ( 0.6 * relevance\_score ) + ( 0.4 * commercial\_score )$$

The weights are tuned to optimize advertisement relevance for users. Higher weights on a relevance score may be used to favor keyword candidates representing the overall meaning of the conversation. Higher weights on a commercial score may be used to favor keyword candidates with a strong connection to commercial offerings. In some examples, the weights are dynamically adjusted using factors like the conversation topic or user profile.

In some examples, the keyword extraction component 354 uses a machine learning model to combine the relevance and commercial scores in a learned manner. The model is trained on examples of keywords and their scores, as well as performance metrics for the advertisements triggered by each keyword. The model learns how to weigh and combine the scores to optimize advertisement relevance for users. The machine learning model enables a more complex analysis of how relevance and commerciality should be balanced when selecting keywords.

In some examples, the keyword extraction component 354 selects a subset of the highest-scoring keyword candidates as the keywords 342 to use for requesting advertising content 346. In some examples, the system selects a single top-scoring keyword candidate as the primary keyword to maximize relevance of the advertising content 346. In other examples, the system selects multiple high-scoring keyword candidates to request a diverse range of advertising content 346. In some examples, a number of keywords 342 selected depends on factors such as, but not limited to, available advertising content inventory, user preferences regarding advertising content, and the like.

In some examples, selecting keywords using a combination of their relevance to the conversation and connection to commercial offerings improves a probability that the selected advertising content 346 aligns with the user's interests and needs. Optimizing the selection process, including tuning score weights and using machine learning, may lead to an enhanced user experience with relevant advertising content.

In operation 312, the advertisement search component 330 transmits the selected keywords 342 to one or more one or more advertising content servers 348 at operation 312. The advertisement search component 330 transmits the selected keywords to the one or more one or more advertising content servers 348 to request advertising content 346 targeting the selected keywords. In some examples, the one or more advertising content servers 348 are third-party advertising content 346 providers that the chatbot system 300 integrates with to display advertisements to users. Transmitting keywords to the one or more advertising content servers 348 allows the chatbot system 300 to request advertising content 346 specifically tailored to what the user 336 wants to discuss or accomplish using their conversation 360 with the chatbot 362.

In some examples, the advertisement search component 330 transmits the selected keywords 342 via an API provided by each advertising content server of the one or more advertising content servers 348.

In some examples, the keywords 342 are sent along with other details about the user 336 and the conversation 360 such as, but not limited to:
A language, location, and other profile information of the user 336 to request locally and culturally relevant advertising content 346.
A conversation topic or subject to request advertising content 346 related to the overall conversation 360. The conversation topic may be inferred from the selected keywords or determined using natural language processing techniques.
Restrictions on advertising content, types, brands, or other attributes using user preferences and advertising content policies. For example, the user 336 may opt out of certain advertising content categories or sensitive content.

In some examples, the one or more advertising content servers 348 use the transmitted keywords and other details to select advertising content 346 from their inventory targeting the keywords 342 and attributes. The one or more advertising content servers 348 analyze relationships between keywords and advertisements using techniques like:
Embeddings: Generating vector representations of keywords and advertising content to find advertising content with a highest semantic similarity.
Topic modeling: Grouping keywords 342 and advertising content 346 into topics to find the best topic match.
Rules-based matching: Manually defining rules for matching keywords 342 to categories of relevant advertising content 346. For example, matching “restaurant” keywords to advertising content 346 for dining and cuisine.

In some examples, transmitting selected keywords to the one or more advertising content servers 348 allows the chatbot system 300 to request and display advertising content 346 tailored to the expressed interests of the user 336 without needing to maintain an advertising content inventory of its own. Integrating with third-party advertising content servers gives the chatbot system 300 access to a wide range of advertising content 346 to choose from for any given conversation.

In some examples, the performance and relevance of the advertising content 346 depend on the quality of the one or more advertising content servers 348 matching algorithms and inventory. Optimizing the integration between the chatbot system 300 and the one or more advertising content servers 348 by the advertisement search component 330 leads to higher advertising content relevance and a better user experience.

In operation 314, the advertisement search component 330 receives advertising content 346 from the one or more advertising content servers 348 where the advertising content 346 is selected by the one or more advertising content servers 348 using the selected keywords 342. For example, the one or more advertising content servers 348 return details on advertising content 346 to display to the user 336 during the conversation 360 such as, but not limited to, advertising content identification or name, content, landing page URL, images, tracking information, and the like.

In operation 316, the chatbot system 300 provides the advertising content 346 to the user 336 during the conversation 360. For example, the advertisement search component 330 communicates the advertising content 346 to the chatbot system 300. The chatbot system 300 receives the advertising content 346 and renders the advertising content 346 within a conversation interface of the chatbot 362 during the conversation 360. Displaying advertising content tailored to the current conversation 360 helps ensure the advertising content 346 is relevant to the needs and interests of the user 336 at the moment in time of the conversation 360.

In some examples, the chatbot system 300 renders visual components of advertisements within the advertising content 346 such as, but not limited to, an advertisement title, content, images, interactive elements, and the like.

In some examples, the chatbot system 300 displays these components prominently within the conversation interface, such as after a certain number of messages or in response to a user prompt.

In some examples, the chatbot system 300 provides a link to an advertisement's landing page. If the user 336 clicks the advertisement, the chatbot system 300 directs the user 336 to the page where the user 336 can engage further with the advertisement or complete a conversion.

In some examples, the chatbot system 300 provides advertisement disclaimers and policies to comply with regulations. For example, the chatbot system 300 may render “Advertisement” labels, age restrictions, or responsible gambling warnings.

In some examples, the chatbot system 300 provides the advertisements in a natural, unobtrusive manner that fits seamlessly into the flow and context of the conversation 360.

In some examples, options for advertisement placement include:
After a certain number of messages: Displaying advertisements at regular intervals during longer conversations. For example, showing an advertisement after every 3rd message.
In response to user prompts: Showing advertisements in response to user messages explicitly requesting information or recommendations related to a product, service, or topic. For example, displaying an advertisement in response to “What's a good movie to watch?”.
At logical breakpoints: Identifying natural pauses or transitions in the conversation flow to insert an advertisement. For example, showing an advertisement after a greeting message or when the discussion shifts to a new topic.
Inline with conversation: Merging the advertisement content directly into the conversation 360 by rephrasing it in the system's own words or generating a message to introduce the advertisement. For example, saying “Here's an advertisement I found for you: [Advertisement Title]” followed by the advertisement content. This approach aims to make the advertisement feel like a natural part of the conversation 360.

In some examples, the chatbot system 300 logs engagement metrics 366 in an engagement metric datastore 338 such as, but not limited to, impressions and clicks on the advertisements of the advertising content 346 to measure performance of individual advertisements of the advertising content 346. The advertisement search component 330 uses the engagement metrics 366 to optimize advertisement placement and the overall user experience leads to higher engagement and satisfaction.

In some examples, the advertisement search component 330 further selects the advertising content 346 using a predicted click-through rate for the user 336. For example, the advertisement search component 330 may select and filter the advertising content 346 further using a predicted click-through rate (CTR) for the individual user using user profile information 368 collected by the chatbot system 300 and stored in a user profile datastore 326. The predicted CTR indicates the likelihood of the user clicking on a given advertisement using their profile and behavior. Selecting advertisements with a higher predicted CTR for the user 336 helps optimize the relevance and performance of the advertisements displayed during the conversation.

In some examples, the advertisement search component 330 generates a predicted CTR for each advertisement using metrics such as, but not limited to:
An advertisement's historical CTR across all users using data from the one or more advertising content servers 348. Advertisements with a higher historical CTR tend to lead to more user clicks, indicating higher relevance and interest.
A machine learning model analyzing the relationship between an advertisement's details, user attributes of the user profile information 368, and the likelihood of the user 336 clicking the advertisement. The model is trained on historical data of the advertisements displayed to the user, their attributes, and whether or not the user 336 clicked each advertisement. The model learns to predict the CTR of new advertisements for the user 336.
Rules or heuristics mapping certain advertisement and user attributes of the user profile information 368 to higher or lower predicted CTRs. For example, an advertisement for a product the user has purchased before may have a higher predicted CTR. Simple rules are easy to implement but less sophisticated than machine learning models.

In some examples, the advertisement search component 330 combines a predicted CTR with other factors like relevance scores, diversity, and advertisement policies to filter and rank individual advertisements of the advertising content 346. Advertisements with a higher predicted CTR for the user are ranked higher, as they represent advertisements the user is more likely to find interesting and engaging. However, the advertisement search component 330 also aims to provide a diverse range of relevant advertisements, so it may filter out advertisements with an extremely low predicted CTR but still display some lower-performing advertisements.

In some examples, using predicted CTRs to filter and rank advertisements helps optimize the user experience by showing advertisements the user 336 is most likely to click first. This approach leads to higher overall CTRs, more advertisement clicks, and increased revenue. The accuracy of the predicted CTRs depends on the amount of historical data available for the user 336 and individual advertisements of the advertising content 346 as well as the accuracy of the machine learning models. Optimizing the advertisement selection process using predicted CTRs, especially as more data becomes available over time, results in a better user experience and performance.

In some examples, the advertisement search component 330 uses a moderation component 320 to detect and abusive language in the keywords 342 and generate a moderation response 350 comprising a report of any abusive language detected in the keywords 342. The moderation component 320 analyzes language and speech to detect abusive, derogatory, or offensive content using natural language processing and machine learning to automatically identify abusive language in the keywords 342. Methodologies used by the moderation component 320 can include, but are not limited to:
Blocklists: Flagging messages containing offensive words and phrases from a predefined list.
Sentiment analysis: Detecting strongly negative sentiments that may indicate abusive content.
Machine learning: Training models on large datasets of messages labeled as abusive or non-abusive. The models learn linguistic patterns and relationships to detect new abusive keywords.
Contextual analysis: Considering the context around words and phrases to determine if they are being used in an abusive manner. For example, the keyword “fat” would be flagged as abusive when used as an insult but not when discussing health and nutrition. Contextual analysis aims to limit false positives.

The advertisement search component 330 receives the moderation response 350 and uses the moderation response 350 to filter abusive keywords from the keywords 342 before communicating the keywords 342 to the one or more advertising content servers 348.

In some examples, the commercial intent model 370 and the one or more keyword extraction model 372 used by the intent determination component 340 and the keyword extraction component 354, respectively, are trained on data comprising translations of labeled examples from a first language into a second language.

In some examples, the chatbot system 300 uses the generative AI model 334 to determine commercial intent 328 using the user messages 318. In some examples, the keyword extraction component 354 uses the generative AI model 334 to determine the keywords 342 using the user messages 318.

In some examples, the advertisement search component 330 accesses user profile information 368 in a user profile of the user 336 stored in a user profile datastore 326. The advertisement search component 330 uses an advertisement user experience component 356 to analyze the user profile information 368 to provide additional context when assigning commercial scores to keyword candidates. The user profile includes details such as, but not limited to:
Demographic information like age, gender, location, and income level. For example, if the user is in a high-income bracket, keyword candidates related to luxury products may receive higher commercial scores.
Interests and hobbies as explicitly provided by the user. For example, if the user lists “photography” as an interest, keyword candidates related to cameras and photo editing software may receive higher commercial scores.
Browsing and purchase history if the user has consented to providing that data. For example, if the user frequently views and buys from clothing retailers, keyword candidates related to apparel and fashion may receive higher commercial scores.
Lifestyle attributes inferred from the user's behavior and activity. For example, if the user frequently exercises and tracks fitness, keyword candidates related to health and wellness products may receive higher commercial scores.
Historical data of which keywords have been previously identified during conversations and their frequency of use in determining advertisements to provide to the user.

In some examples, the user profile provides a broad range of attributes and interests outside of the current conversation that give context to the user's potential needs and commercial intent. The system combines this additional context with the conversation context to determine which keyword candidates are most commercially relevant for that user. For example, if the user 336 asks for movie recommendations and the keyword “action” is extracted, the advertisement search component 330 may check if the user profile information 368 lists “action and adventure” as an interest or if the viewing history of the user 336 shows a preference for those genres. If so, the advertisement search component 330 assigns a higher commercial score to “action”. In another example, if an advertisement for pet supplies is received as part of the advertising content 346 but the current conversation 360 contains no indication the user 336 has pets, the advertisement search component 330 may still display the advertisement if the user profile information 368 of the user profile datastore 326 shows the user follows multiple pet brands and frequently views pet-related content.

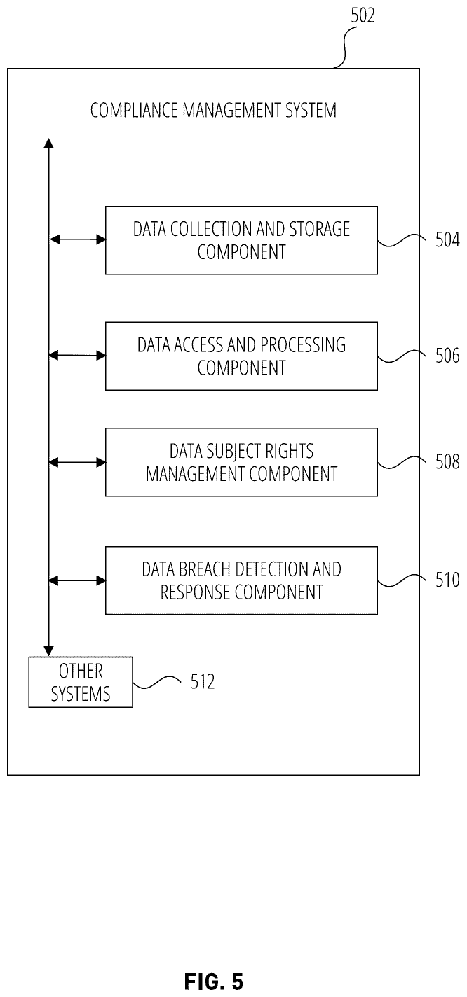

Accessing the user profile information 368 allows the advertisement search component 330 to tailor advertisement experiences to the user's unique interests and attributes. However, in some examples, users explicitly consent to providing access to their user profile datastore 326 for advertisement personalization purposes in accordance with a compliance management system 502 (of FIG. 5) as more fully described in reference to FIG. 5.

In some examples, the advertisement search component 330 uses the advertisement user experience component 356 to further customize a user experience of the user 336 using information about what keywords that were previously processed during a conversation 360 between the user 336 and the chatbot 362, and thus what advertisements may have already been provided to the user 336. For example, the advertisement user experience component 356 receives the keywords 342 selected for transmission to the one or more advertising content servers 348 and filters the keywords 342 using historical data of advertisements and keywords previously provided to the user 336. The advertisement user experience component 356 returns an advertisement user experience response 352 to the advertisement search component 330 and the advertisement search component 330 uses the advertisement user experience response 352 to further refine the keywords 342 that are communicated to the one or more advertising content servers 348. This helps alleviate a problem of providing too many of the same advertisements to the user 336.

In some examples, the chatbot system 300 may analyze messages from multiple users participating in a group chat conversation to determine commercial intent 328 and extract keyword candidates for the generation of the advertising content 346. A group chat contains messages from more than one user, so the chatbot system 300 considers the discussion context and interests of all participants when analyzing the conversation. For example, to detect commercial intent 328 in a group chat, the intent determination component 340 determines if any participant expresses a need or interest that could be fulfilled by a commercial product or service. For example, if one user asks for movie recommendations and another user expresses interest in seeing an action film, the intent determination component 340 detects commercial intent related to movies and entertainment. The intent determination component 340 may assign a higher commercial intent score when multiple users discuss the same topic or express similar needs.

In some examples, when extracting keyword candidates from a group chat, the keyword extraction component 354 identifies keywords, phrases, and topics discussed by any of the participants. The keyword extraction component 354 ranks these keyword candidates using factors such as, but not limited to:
Frequency of mention across all messages in the conversation. Keyword candidates discussed by multiple users receive higher relevance scores.
The context in which each user mentions the keyword candidate. Keyword candidates mentioned in an enthusiastic, positive context by multiple users receive higher relevance scores.
The interests and relationships between participants as determined from their profiles and conversation history. Keyword candidates aligning with interests shared by most or all participants receive higher relevance scores.

The keyword extraction component 354 filters and ranks the received advertisements for display in the group chat using the combined commercial intent and keyword candidates from all participants. This aims to show advertisements of the advertising content 346 that are relevant to the shared interests and needs expressed in the conversation of the group chat. For example, if multiple users discuss watching an action movie together, the chatbot system 300 may display advertisements for the latest blockbuster action films.

In some examples, analyzing messages from all group chat participants provides a more complete view of the conversation context and shared interests within the group. This allows the intent determination component 340 to determine commercial intent and the keyword extraction component 354 to extract keyword candidates that represent the needs and interests of the group as a whole rather than any single individual. The chatbot system 300 can then provide advertisement experiences tailored to the group discussion and relationships. However, privacy controls are used to allow group chat participants to opt out of advertisement personalization and delete their messages if desired in accordance with the compliance management system 502.

FIG. 4A is a process flow diagram depicting a machine learning and deployment process 416 and FIG. 4B is an illustration of a machine learning and deployment pipeline 446, according to some examples. The machine learning and deployment pipeline 446 may be used to generate a trained machine-learning program 418 such as, but not limited to, a generative AI model 334, a commercial intent model 370, a keyword extraction model 372, or a model used by a moderation component 320 (all of FIG. 3A), to perform operations associated with searches and query responses of the chatbot system 300 (of FIG. 3A).

### Overview

Broadly, machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable using one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions using the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

Generating a trained machine-learning program 418 may include multiple phases that form part of the machine learning and deployment pipeline 446, including for example the following phases illustrated in FIG. 4A:
Data collection and preprocessing 402: This phase may include acquiring and cleaning data to ensure that it is suitable for use in the machine learning model. This phase may also include removing duplicates, handling missing values, and converting data into a suitable format.
Feature engineering 404: This phase may include selecting and transforming the training data 422 to create features that are useful for predicting the target variable. Feature engineering may include (1) receiving features 424 (e.g., as structured or labeled data in supervised learning) and/or (2) identifying features 424 (e.g., unstructured or unlabeled data for unsupervised learning) in training data 422.
Model selection and training 406: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 408: This phase may include evaluating the performance of a trained model (e.g., the trained machine-learning program 418) on a separate testing dataset. This phase can help determine if the model is overfitting or underfitting and determine whether the model is suitable for deployment.
Prediction 410: This phase involves using a trained model (e.g., trained machine-learning program 418) to generate predictions on new, unseen data.
Validation, refinement or retraining 412: This phase may include updating a model using feedback generated from the prediction phase, such as new data or user feedback.
Deployment 414: This phase may include integrating the trained model (e.g., the trained machine-learning program 418) into a more extensive system or application, such as a web service, mobile app, or IoT device. This phase can involve setting up APIs, building a user interface, and ensuring that the model is scalable and can handle large volumes of data.

FIG. 4B illustrates further details of two example phases, namely a training phase 420 (e.g., part of the model selection and trainings 406) and a prediction phase 426 (part of prediction 410). Prior to the training phase 420, feature engineering 404 is used to identify features 424. This may include identifying informative, discriminating, and independent features for effectively operating the trained machine-learning program 418 in pattern recognition, classification, and regression. In some examples, the training data 422 includes labeled data, known for pre-identified features 424 and one or more outcomes. Each of the features 424 may be a variable or attribute, such as an individual measurable property of a process, article, system, or phenomenon represented by a data set (e.g., the training data 422). Features 424 may also be of different types, such as numeric features, strings, and graphs, and may include one or more of content 428, concepts 430, attributes 432, historical data 434, and/or user data 436, merely for example.

In training phase 420, the machine learning and deployment pipeline 446 uses the training data 422 to find correlations among the features 424 that affect a predicted outcome or prediction/inference data 438.

With the training data 422 and the identified features 424, the trained machine-learning program 418 is trained during the training phase 420 during machine-learning program training 440. The machine-learning program training 440 appraises values of the features 424 as they correlate to the training data 422. The result of the training is the trained machine-learning program 418 (e.g., a trained or learned model).

Further, the training phase 420 may involve machine learning, in which the training data 422 is structured (e.g., labeled during preprocessing operations). The trained machine-learning program 418 implements a neural network 442 capable of performing, for example, classification and clustering operations. In other examples, the training phase 420 may involve deep learning, in which the training data 422 is unstructured, and the trained machine-learning program 418 implements a deep neural network 442 that can perform both feature extraction and classification/clustering operations.

In some examples, a neural network 442 may be generated during the training phase 420, and implemented within the trained machine-learning program 418. The neural network 442 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 442 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 442 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 420, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 426, the trained machine-learning program 418 uses the features 424 for analyzing query data 444 to generate inferences, outcomes, or predictions, as examples of a prediction/inference data 438. For example, during prediction phase 426, the trained machine-learning program 418 generates an output. Query data 444 is provided as an input to the trained machine-learning program 418, and the trained machine-learning program 418 generates the prediction/inference data 438 as output, responsive to receipt of the query data 444.

In some examples, the trained machine-learning program 418 may be a generative AI model. Generative AI is a term that may refer to any type of artificial intelligence that can create new content from training data 422. For example, generative AI can produce text, images, video, audio, code, or synthetic data similar to the original data but not identical. Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GNNs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data using these relationships. Transformer models can handle sequential data, such as text or speech, as well as non-sequential data, such as images or code.

In generative AI examples, the output prediction/inference data 438 include predictions, translations, summaries or media content.

FIG. 5 is a block diagram illustrating an automated compliance management system 502, according to some examples, which may be deployed as part of a broader platform hosting a chatbot system 300 (of FIG. 3A) to facilitate compliance with various data privacy and other legislative requirements, such as those of the General Data Protection Regulation (GDPR), Digital Services Act (DSA), California Consumer Privacy Act (CCPA), and other global privacy requirements. The compliance management system 502 operates with other systems 512 of a platform to implement user privacy and data protections and provide an environment in which an online platform can safely and responsibly operate.

Components of the compliance management system 502 may include:
A data collection and storage component 504 is responsible for securely handling user data in a way that is compliant with GDPR, DSA, CCPA, and other privacy requirements. The data collection and storage component 504 includes the following sub-components:
   Data Input Validation: This sub-component validates user input, ensuring that only necessary data is collected and stored. It uses algorithms to filter out any unnecessary information. The input validation sub-component can be designed to prevent the storage of personal information (e.g., biometric information) without explicit notification and consent from the user. To achieve this, the input validation sub-component can incorporate additional functionality including:
      Consent Detection: Before collecting and processing biometric data, the input validation sub-component may check if explicit consent has been obtained from the user. This can be done by verifying the user's consent status in a compliance management system 502, or by checking for the presence of consent-related metadata associated with the biometric data.
      Consent-Based Filtering: The input validation sub-component may allow biometric data to be stored only if the required consent has been obtained. If consent is absent, the sub-component filters out the biometric data and prevents it from being stored. This ensures that a platform only processes biometric data when appropriate consent has been given.
      Notification and Consent Management: The input validation sub-component works with a consent (e.g., opt-in/opt-out) management system that handles user notifications and manages consent records. This system may notify users about the collection and use of biometric data, provide them with the option to give or withdraw their consent, and maintain a record of the users' consent status.
Opt-in/Opt-out Management: This sub-component handles user preferences and consents for data collection and processing. It provides users with mechanisms for opting in or out of specific data processing activities, in accordance with privacy regulations.
Secure Data Storage: This sub-component stores user data using encryption, ensuring that it is protected from unauthorized access. It may use a combination of symmetric and asymmetric encryption algorithms (e.g., Advanced Encryption Standard (AES) and Rivest-Shamir-Adleman (RSA)) for maximum security.
Data Retention Policy: This sub-component enforces a data retention policy, which specifies the duration for which user data is retained. After the specified duration, data is automatically deleted using secure deletion algorithms.
Data Minimization: This sub-component ensures that a minimum amount of data necessary for specific purposes is collected and stored. It adheres to the data minimization principle in various privacy regulations, reducing the risk of unauthorized access or misuse of excessive user data. This sub-component ensures that biometric data collection is limited to what is strictly necessary for the intended purpose, in compliance with privacy regulations.
Data Categorization and Classification: This sub-component categorizes and classifies user data using its sensitivity and the level of protection required. By assigning different levels of security to various data types, it helps ensure that sensitive data receives an appropriate level of protection. This sub-component also recognizes biometric data as a sensitive category of personal data and ensures that it is treated with the appropriate level of protection.
Data Inventory Management: This sub-component maintains an up-to-date inventory of all user data collected and stored, including information about the data's purpose, location, and retention period. It enables management and tracking of user data, simplifying compliance with privacy requirements.
Privacy Impact Assessment (PIA): This sub-component evaluates the potential privacy risks associated with new data collection and storage processes or technologies. By identifying and mitigating potential risks before implementing changes, it helps maintain compliance with privacy requirements and protect user data.
Data Transfer Management: This sub-component manages and secures data transfers between different systems, services, or third parties. It ensures that data transfers are compliant with privacy requirements and that data is protected during transit using encryption and other security measures.
A data access and processing component 506 is responsible for providing controlled access to user data and ensuring that data is processed in a compliant manner. The data access and processing component 506 may include the following sub-components:
   Access Control: This sub-component manages user data access, granting access only to authorized users and services. It may use role-based access control (RBAC) to assign permissions using user roles and responsibilities.
   Data Processing Management: This sub-component ensures that data processing is compliant with GDPR, DSA, CCPA, and other privacy regulations. It uses algorithms to automatically anonymize or pseudonymize user data when required, takes into account user opt-in/opt-out preferences, and logs data processing activities for auditing purposes. This sub-component also ensures that biometric data processing complies with specific requirements and restrictions set forth by GDPR, CCPA, and other privacy regulations. This may include obtaining explicit consent from the individual, processing for specific purposes, or anonymizing and pseudonymizing biometric data when required.
A data subject rights management component 508 is responsible for managing and facilitating user rights requests as per GDPR, DSA, CCPA, and other privacy regulations. The data subject rights management component 508 may include the following sub-components:
   User Rights Request Processing: This sub-component processes user rights requests, such as data access, rectification, erasure, data portability, and opt-out requests. It uses algorithms to automatically validate and execute these requests, ensuring compliance and timely responses.
   User Rights Request Logging: This sub-component logs all user rights requests and their outcomes, creating an audit trail that can be reviewed for compliance purposes.
A data breach detection and response component 510 is responsible for detecting and responding to data breaches in a timely and compliant manner. The data breach detection and response component 510 may include the following sub-components:
   Data Breach Detection: This sub-component uses machine learning algorithms to continuously monitor and analyze the system for any signs of data breaches or unauthorized access.
   Data Breach Response: This sub-component initiates predefined incident response procedures in case of a detected data breach. It ensures that the breach is contained, assessed, and reported to the relevant authorities as required by GDPR, DSA, CCPA, and other privacy regulations.

The compliance management system 502 is designed to provide a comprehensive solution for social media platforms to comply with GDPR, DSA, CCPA, and other privacy requirements. By implementing secure data collection and storage, controlled data access and processing, user rights management, and data breach detection and response components, the system ensures user privacy and data protection while enabling responsible platform operation. The inclusion of opt-in/opt-out management, along with other privacy controls, further empowers users to manage their data preferences and helps the platform maintain compliance with evolving privacy regulations.

### Data Architecture

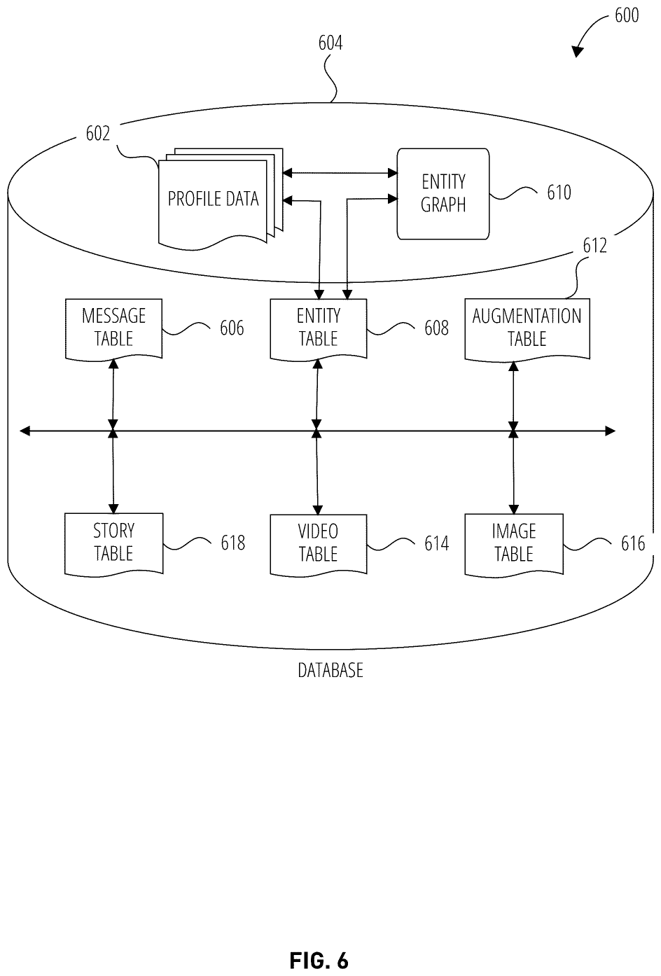

FIG. 6 is a schematic diagram illustrating data structures 600, which may be stored in the database 604 of the interactive server system 110, according to certain examples. While the content of the database 604 is shown to comprise multiple tables, it will be appreciated that the data could be stored in other types of data structures (e.g., as an object-oriented database).

The database 604 includes message data stored within a message table 606. This message data includes, for any particular message, at least message sender data, message recipient (or receiver) data, and a payload. Further details regarding information that may be included in a message, and included within the message data stored in the message table 606, are described below with reference to FIG. 6.

An entity table 608 stores entity data, and is linked (e.g., referentially) to an entity graph 610 and profile data 602. Entities for which records are maintained within the entity table 608 may include individuals, corporate entities, organizations, objects, places, events, and so forth. Regardless of entity type, any entity regarding which the interactive server system 110 stores data may be a recognized entity. Each entity is provided with a unique identifier, as well as an entity type identifier (not shown).

The entity graph 610 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interactive platform 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 608. Such privacy settings may be applied to all types of relationships within the context of the interactive platform 100, or may selectively be applied to only certain types of relationships.

The profile data 602 stores multiple types of profile data about a particular entity. The profile data 602 may be selectively used and presented to other users of the interactive platform 100 based on privacy settings specified by a particular entity. Where the entity is an individual, the profile data 602 includes, for example, a username, telephone number, address, settings (e.g., notification and privacy settings), as well as a user-selected avatar representation (or collection of such avatar representations). A particular user may then selectively include one or more of these avatar representations within the content of messages communicated via the interactive platform 100, and on map interfaces displayed by interaction clients 104 to other users. The collection of avatar representations may include “status avatars,” which present a graphical representation of a status or activity that the user may select to communicate at a particular time.

Where the entity is a group, the profile data 602 for the group may similarly include one or more avatar representations associated with the group, in addition to the group name, members, and various settings (e.g., notifications) for the relevant group.

The database 604 also stores augmentation data, such as overlays or filters, in an augmentation table 612. The augmentation data is associated with and applied to videos (for which data is stored in a video table 614) and images (for which data is stored in an image table 616).

Filters, in some examples, are overlays that are displayed as overlaid on an image or video during presentation to a message receiver. Filters may be of various types, including user-selected filters from a set of filters presented to a message sender by the interaction client 104 when the message sender is composing a message. Other types of filters include geolocation filters (also known as geo-filters), which may be presented to a message sender based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a message sender by the interaction client 104 based on other inputs or information gathered by the user system 102 during the message creation process. Examples of data filters include current temperature at a specific location, a current speed at which a message sender is traveling, battery life for a user system 102, or the current time.

Other augmentation data that may be stored within the image table 616 includes augmented reality content items (e.g., corresponding to applying Lenses or augmented reality experiences). An augmented reality content item may be a real-time special effect and sound that may be added to an image or a video.

As described above, augmentation data includes augmented reality (AR), virtual reality (VR) and mixed reality (MR) content items, overlays, image transformations, images, and modifications that may be applied to image data (e.g., videos or images). This includes real-time modifications, which modify an image as it is captured using device sensors (e.g., one or multiple cameras) of the user system 102 and then displayed on a screen of the user system 102 with the modifications. This also includes modifications to stored content, such as video clips in a collection or group that may be modified. For example, in a user system 102 with access to multiple augmented reality content items, a user can use a single video clip with multiple augmented reality content items to see how the different augmented reality content items will modify the stored clip. Similarly, real-time video capture may use modifications to show how video images currently being captured by sensors of a user system 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudorandom animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects, and using transformations and animated textures of the model within the video to achieve the transformation. In some examples, tracking of points on an object may be used to place an image or texture (which may be two-dimensional or three-dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device, or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of an object's elements, characteristic points for each element of an object are calculated (e.g., using an Active Shape Model (ASM) or other known methods). Then, a mesh based on the characteristic points is generated for each element of the object. This mesh is used in the following stage of tracking the elements of the object in the video stream. In the process of tracking, the mesh for each element is aligned with a position of each element. Then, additional points are generated on the mesh.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification, properties of the mentioned areas can be transformed in different ways. Such modifications may involve changing the color of areas; removing some part of areas from the frames of the video stream; including new objects into areas that are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation.

In some examples of a computer animation model to transform image data using face detection, the face is detected on an image using a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

A transformation system can capture an image or video stream on a client device (e.g., the user system 102) and perform complex image manipulations locally on the user system 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the user system 102.

In some examples, a computer animation model to transform image data can be used by a system where a user may capture an image or video stream of the user (e.g., a selfie) using the user system 102 having a neural network operating as part of an interaction client 104 operating on the user system 102. The transformation system operating within the interaction client 104 determines the presence of a face within the image or video stream and provides modification icons associated with a computer animation model to transform image data, or the computer animation model can be present as associated with an interface described herein. The modification icons include changes that are the basis for modifying the user's face within the image or video stream as part of the modification operation. Once a modification icon is selected, the transform system initiates a process to convert the image of the user to reflect the selected modification icon (e.g., generate a smiling face on the user). A modified image or video stream may be presented in a graphical user interface displayed on the user system 102 as soon as the image or video stream is captured and a specified modification is selected. The transformation system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine-taught neural networks may be used to enable such modifications.

The graphical user interface, presenting the modification performed by the transform system, may supply the user with additional interaction options. Such options may be based on the interface used to initiate the content capture and selection of a particular computer animation model (e.g., initiation from a content creator user interface). In various examples, a modification may be persistent after an initial selection of a modification icon. The user may toggle the modification on or off by tapping or otherwise selecting the face being modified by the transformation system and store it for later viewing or browsing to other areas of the imaging application. Where multiple faces are modified by the transformation system, the user may toggle the modification on or off globally by tapping or selecting a single face modified and displayed within a graphical user interface. In some examples, individual faces, among a group of multiple faces, may be individually modified, or such modifications may be individually toggled by tapping or selecting the individual face or a series of individual faces displayed within the graphical user interface.

A story table 618 stores data regarding collections of messages and associated image, video, or audio data, which are compiled into a collection (e.g., a story or a gallery). The creation of a particular collection may be initiated by a particular user (e.g., each user for which a record is maintained in the entity table 608). A user may create a “personal story” in the form of a collection of content that has been created and sent/broadcast by that user. To this end, the user interface of the interaction client 104 may include an icon that is user-selectable to enable a message sender to add specific content to his or her personal story.

A collection may also constitute a “live story,” which is a collection of content from multiple users that is created manually, automatically, or using a combination of manual and automatic methodologies. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may require a second degree of authentication to verify that the end-user belongs to a specific organization or other entity (e.g., is a student on the university campus).

As mentioned above, the video table 614 stores video data that, in some examples, is associated with messages for which records are maintained within the message table 606. Similarly, the image table 616 stores image data associated with messages for which message data is stored in the entity table 608. The entity table 608 may associate various augmentations from the augmentation table 612 with various images and videos stored in the image table 616 and the video table 614.

The databases 604 also include social network information collected by an interactive platform of an interaction system. The social network information may include without limitation relationship and communication data for users of the interactive platform. The social network information can be used to group two or more users and offer additional functionality of the interactive platform 100. Examples of relationships include, but are not limited to, best friends relationships where two or more users are determined to be mutual best friends based on a frequency of their interactions, users who have common interests in current events, users who share an affiliation through social clubs or philanthropic organizations, and the like. Examples of communications include without limitation chats, private and public messages, exchanges of media such as images, videos, audio recordings, and the like.

### Data Communications Architecture

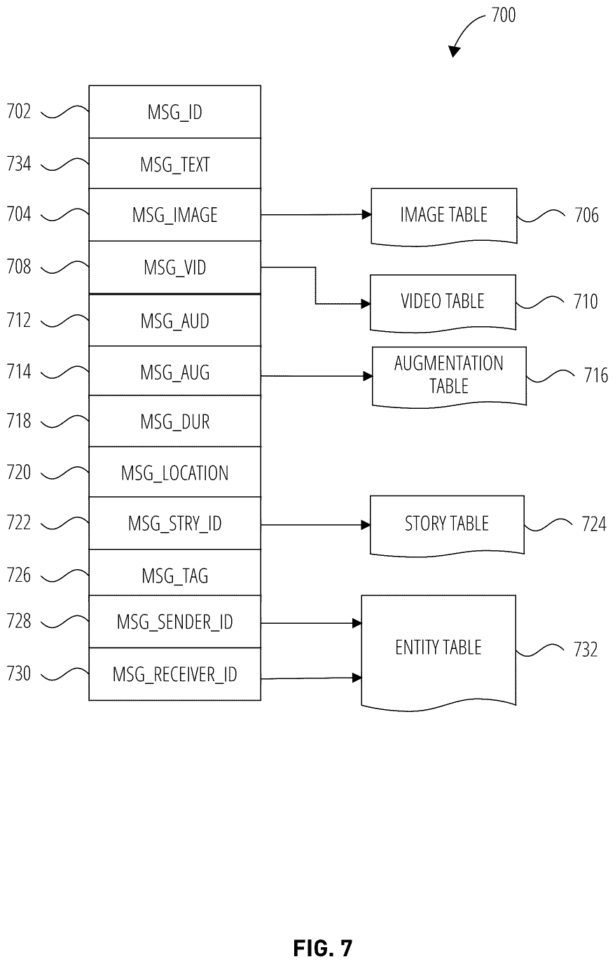

FIG. 7 is a schematic diagram illustrating a structure of a message 700, according to some examples, generated by an interaction client 104 for communication to a further interaction client 104 via the interaction servers 124. The content of a particular message 700 is used to populate the message table 606 stored within the database 604, accessible by the interaction servers 124. Similarly, the content of a message 700 is stored in memory as “in-transit” or “in-flight” data of the user system 102 or the interaction servers 124. A message 700 is shown to include the following example components:
Message identifier 702: a unique identifier that identifies the message 700.
Message text payload 734: text, to be generated by a user via a user interface of the user system 102, and that is included in the message 700.
Message image payload 704: image data, captured by a camera component of a user system 102 or retrieved from a memory component of a user system 102, and that is included in the message 700. Image data for a sent or received message 700 may be stored in the image table 706.
Message video payload 708: video data, captured by a camera component or retrieved from a memory component of the user system 102, and that is included in the message 700. Video data for a sent or received message 700 may be stored in the video table 710.
Message audio payload 712: audio data, captured by a microphone or retrieved from a memory component of the user system 102, and that is included in the message 700.
Message augmentation data 714: augmentation data (e.g., filters, stickers, or other annotations or enhancements) that represents augmentations to be applied to message image payload 704, message video payload 708, or message audio payload 712 of the message 700. Augmentation data for a sent or received message 700 may be stored in the augmentation table 716.
Message duration parameter 718: parameter value indicating, in seconds, the amount of time for which content of the message (e.g., the message image payload 704, message video payload 708, message audio payload 712) is to be presented or made accessible to a user via the interaction client 104.
Message geolocation parameter 720: geolocation data (e.g., latitudinal and longitudinal coordinates) associated with the content payload of the message. Multiple message geolocation parameter 720 values may be included in the payload, each of these parameter values being associated with respect to content items included in the content (e.g., a specific image within the message image payload 704, or a specific video in the message video payload 708).
Message story identifier 722: identifier values identifying one or more content collections (e.g., “stories” identified in the story table 724) with which a particular content item in the message image payload 704 of the message 700 is associated. For example, multiple images within the message image payload 704 may each be associated with multiple content collections using identifier values.
Message tag 726: each message 700 may be tagged with multiple tags, each of which is indicative of the subject matter of content included in the message payload. For example, where a particular image included in the message image payload 704 depicts an animal (e.g., a lion), a tag value may be included within the message tag 726 that is indicative of the relevant animal. Tag values may be generated manually, based on user input, or may be automatically generated using, for example, image recognition.
Message sender identifier 728: an identifier (e.g., a messaging system identifier, email address, or device identifier) indicative of a user of the user system 102 on which the message 700 was generated and from which the message 700 was sent.
Message receiver identifier 730: an identifier (e.g., a messaging system identifier, email address, or device identifier) indicative of a user of the user system 102 to which the message 700 is addressed.

The contents (e.g., values) of the various components of message 700 may be pointers to locations in tables within which content data values are stored. For example, an image value in the message image payload 704 may be a pointer to (or address of) a location within an image table 706. Similarly, values within the message video payload 708 may point to data stored within a video table 710, values stored within the message augmentation data 714 may point to data stored in an augmentation table 716, values stored within the message story identifier 722 may point to data stored in a story table 724, and values stored within the message sender identifier 728 and the message receiver identifier 730 may point to user records stored within an entity table 732.

### Machine Architecture

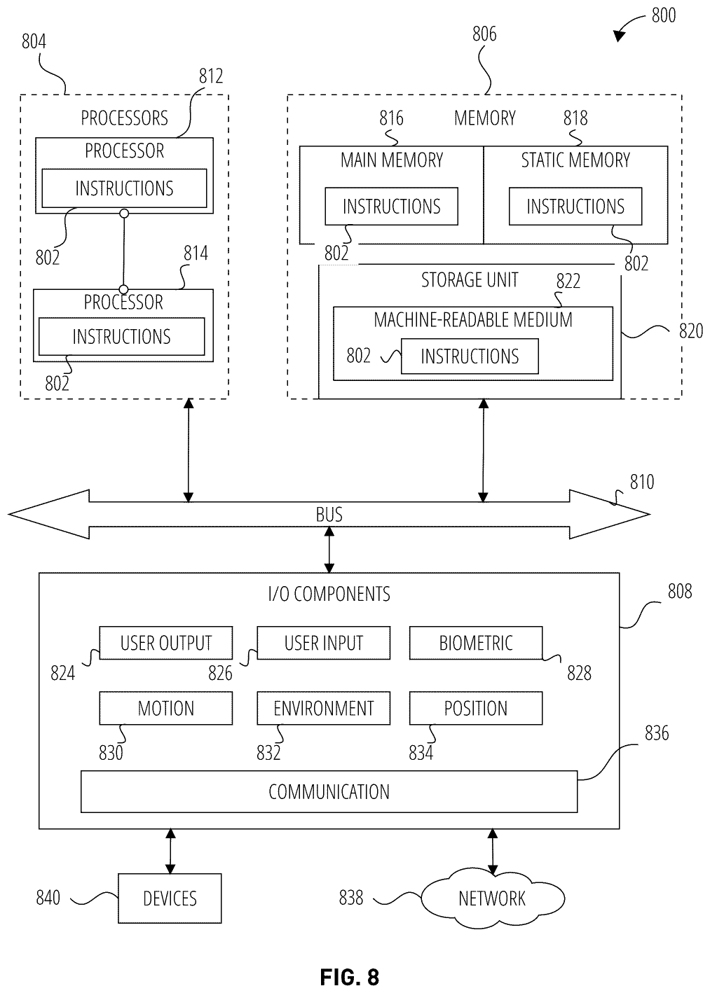

FIG. 8 is a diagrammatic representation of the machine 800 within which instructions 802 (e.g., software, a program, an application, an applet, an app, or other executable code) for causing the machine 800 to perform any one or more of the methodologies discussed herein may be executed. For example, the instructions 802 may cause the machine 800 to execute any one or more of the methods described herein. The instructions 802 transform the general, non-programmed machine 800 into a particular machine 800 programmed to carry out the described and illustrated functions in the manner described. The machine 800 may operate as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a computing apparatus, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 802, sequentially or otherwise, that specify actions to be taken by the machine 800. Further, while a single machine 800 is illustrated, the term “machine” shall also be taken to include a collection of machines that individually or jointly execute the instructions 802 to perform any one or more of the methodologies discussed herein. The machine 800, for example, may comprise the user system 102 or any one of multiple server devices forming part of the interactive server system 110. In some examples, the machine 800 may also comprise both client and server systems, with certain operations of a particular method or algorithm being performed on the server-side and with certain operations of the particular method or algorithm being performed on the client-side.

The machine 800 may include processors 804, memory 806, and input/output I/O components 808, which may be configured to communicate with each other via a bus 810. In an example, the processors 804 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 812 and a processor 814 that execute the instructions 802. The term “processor” is intended to include multi-core processors that may comprise two or more independent processors (sometimes referred to as “cores”) that may execute instructions contemporaneously. Although FIG. 8 shows multiple processors 804, the machine 800 may include a single processor with a single-core, a single processor with multiple cores (e.g., a multi-core processor), multiple processors with a single core, multiple processors with multiples cores, or any combination thereof.

The memory 806 includes a main memory 816, a static memory 818, and a storage unit 820, both accessible to the processors 804 via the bus 810. The main memory 806, the static memory 818, and storage unit 820 store the instructions 802 embodying any one or more of the methodologies or functions described herein. The instructions 802 may also reside, completely or partially, within the main memory 816, within the static memory 818, within machine-readable medium 822 within the storage unit 820, within at least one of the processors 804 (e.g., within the processor's cache memory), or any suitable combination thereof, during execution thereof by the machine 800.

The I/O components 808 may include a wide variety of components to receive input, provide output, produce output, transmit information, exchange information, capture measurements, and so on. The specific I/O components 808 that are included in a particular machine will depend on the type of machine. For example, portable machines such as mobile phones may include a touch input device or other such input mechanisms, while a headless server machine will likely not include such a touch input device. It will be appreciated that the I/O components 808 may include many other components that are not shown in FIG. 8. In various examples, the I/O components 808 may include user output components 824 and user input components 826. The user output components 824 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 826 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 808 may include biometric components 828, motion components 830, environmental components 832, or position components 834, among a wide array of other components. For example, the biometric components 828 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 830 include acceleration sensor components (e.g., accelerometer), gravitation sensor components, rotation sensor components (e.g., gyroscope). The biometric components may include a brain-machine interface (BMI) system that allows communication between the brain and an external device or machine. This is achieved by recording brain activity, translating it into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which involve surgically implanting electrodes directly into the brain.
Optogenetics BMIs, which use light to control the activity of specific nerve cells in the brain.
Functional magnetic resonance imaging (fMRI)-based BMIs, which use magnetic fields to measure blood flow in the brain, which can be used to infer brain activity.

The environmental components 832 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 834 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 808 further include communication components 836 operable to couple the machine 800 to a network 838 or devices 840 via respective coupling or connections. For example, the communication components 836 may include a network interface component or another suitable device to interface with the network 838. In further examples, the communication components 836 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 840 may be another machine or any of a wide variety of peripheral devices (e.g., a peripheral device coupled via a USB).

Moreover, the communication components 836 may detect identifiers or include components operable to detect identifiers. For example, the communication components 836 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 836, such as location via Internet Protocol (IP) geolocation, location via Wi-Fi® signal triangulation, location via detecting an NFC beacon signal that may indicate a particular location, and so forth.

The various memories (e.g., main memory 816, static memory 818, and memory of the processors 804) and storage unit 820 may store one or more sets of instructions and data structures (e.g., software) embodying or used by any one or more of the methodologies or functions described herein. These instructions (e.g., the instructions 802), when executed by processors 804, cause various operations to implement the disclosed examples.

The instructions 802 may be transmitted or received over the network 838, using a transmission medium, via a network interface device (e.g., a network interface component included in the communication components 836) and using any one of several well-known transfer protocols (e.g., hypertext transfer protocol (HTTP)). Similarly, the instructions 802 may be transmitted or received using a transmission medium via a coupling (e.g., a peer-to-peer coupling) to the devices 840.

### Software Architecture

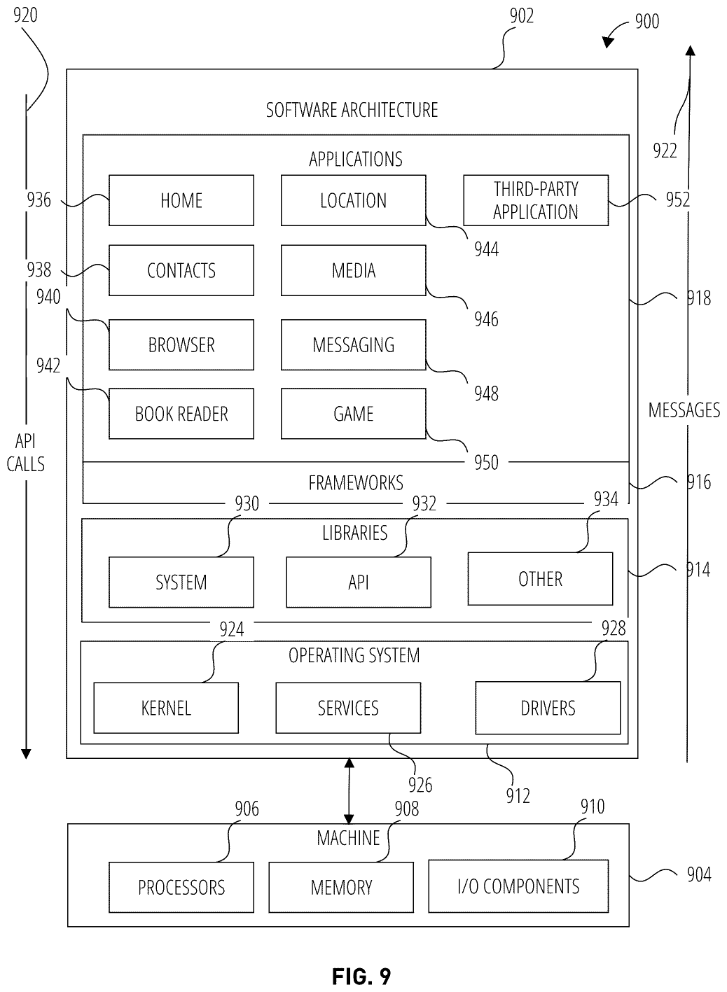

FIG. 9 is a block diagram 900 illustrating a software architecture 902, which can be installed on any one or more of the devices described herein. The software architecture 902 is supported by hardware such as a machine 904 that includes processors 906, memory 908, and I/O components 910. In this example, the software architecture 902 can be conceptualized as a stack of layers, where each layer provides a particular functionality. The software architecture 902 includes layers such as an operating system 912, libraries 914, frameworks 916, and applications 918. Operationally, the applications 918 invoke API calls 920 through the software stack and receive messages 922 in response to the API calls 920.

The operating system 912 manages hardware resources and provides common services. The operating system 912 includes, for example, a kernel 924, services 926, and drivers 928. The kernel 924 acts as an abstraction layer between the hardware and the other software layers. For example, the kernel 924 provides memory management, processor management (e.g., scheduling), component management, networking, and security settings, among other functionalities. The services 926 can provide other common services for the other software layers. The drivers 928 are responsible for controlling or interfacing with the underlying hardware. For instance, the drivers 928 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 914 provide a common low-level infrastructure used by the applications 918. The libraries 914 can include system libraries 930 (e.g., C standard library) that provide functions such as memory allocation functions, string manipulation functions, mathematic functions, and the like. In addition, the libraries 914 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 914 can also include a wide variety of other libraries 934 to provide many other APIs to the applications 918.

The frameworks 916 provide a common high-level infrastructure that is used by the applications 918. For example, the frameworks 916 provide various graphical user interface (GUI) functions, high-level resource management, and high-level location services. The frameworks 916 can provide a broad spectrum of other APIs that can be used by the applications 918, some of which may be specific to a particular operating system or platform.

In an example, the applications 918 may include a home application 936, a contacts application 938, a browser application 940, a book reader application 942, a location application 944, a media application 946, a messaging application 948, a game application 950, and a broad assortment of other applications such as a third-party application 952. The applications 918 are programs that execute functions defined in the programs. Various programming languages can be employed to create one or more of the applications 918, structured in a variety of manners, such as object-oriented programming languages (e.g., Objective-C, Java, or C++) or procedural programming languages (e.g., C or assembly language). In a specific example, the third-party application 952 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 952 can invoke the API calls 920 provided by the operating system 912 to facilitate functionalities described herein.

Further examples include:

Example 1. A method comprising: detecting a commercial intent during a conversation between a user and a chatbot; in response to detecting the commercial intent, performing operations comprising: extracting keyword candidates from the conversation; assigning a relevance score to each keyword candidate using a meaning of the conversation; assigning a commercial score to each keyword candidate using a machine learning model trained to detect commercially related keywords; selecting keywords using a combination of the relevance scores and commercial scores; transmitting the selected keywords to one or more advertising content servers; receiving one or more advertisements from the one or more advertising content servers, the one or more advertisements selected by the one or more advertising content servers using the selected keywords; and providing the advertisements to the user during the conversation.

Example 2. The method of example 1, further comprising: integrating the advertisements into responses from the chatbot.

Example 3. The method of any of examples 1-2, wherein the advertisements are selected further using a predicted click-through rate for the user.

Example 4. The method of any of examples 1-3, wherein the machine learning model is trained on data comprising translations of labeled examples from a first language into a second language.

Example 5. The method of any of examples 1-4, further comprising: accessing a long-term memory of the user's conversations to provide contextual information for assigning the commercial scores.

Example 6. The method of any of examples 1-5, further comprising: accessing user profile data to provide contextual information for assigning the commercial scores.

Example 7. The method of any of examples 1-6, wherein the conversation comprises a group chat, and wherein the method further comprises: analyzing messages from multiple users in the group chat.

Example 8. At least one machine-readable medium including instructions that, when executed by one or more processors, cause the machine to perform operations to implement any of examples 1-7.

Example 9 is a machine comprising means to implement of any of examples 1-7.

### CONCLUSION

Changes and modifications may be made to the disclosed examples without departing from the scope of the present disclosure. These and other changes or modifications are intended to be included within the scope of the present disclosure.

### Glossary

“Carrier signal” refers to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an advertisement hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Machine-readable storage medium” refers to both machine-storage media and transmission media. Thus, the terms include both storage devices/media and carrier waves/modulated data signals. The terms “computer-readable medium,” “machine-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory machine-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

In this disclosure and appended claims, the terms “a” or “an” are used, as is common in patent documents, to include one or more than one, independent of any other instances or usages of “at least one” or “one or more.” In this disclosure and appended claims, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the appended claims, the terms “including” and “comprising” are open-ended; that is, a system, device, article, or process that includes elements in addition to those listed after such a term in a claim is still deemed to fall within the scope of that claim.

What is claimed is:

1. A method comprising:
detecting, by one or more processors, a commercial intent during a conversation between a user and a chatbot; and
in response to detecting the commercial intent, performing, by the one or more processors, operations comprising:
extracting, by the one or more processors, keyword candidates from the conversation;
assigning, by the one or more processors, a relevance score to each keyword candidate using a meaning of the conversation;
assigning, by the one or more processors, a commercial score to each keyword candidate using a machine learning model trained to detect commercially related keywords;
selecting, by the one or more processors, keywords using a combination of the relevance scores and commercial scores;
transmitting, by the one or more processors, the selected keywords to one or more advertising content servers;
receiving, by the one or more processors, one or more advertisements from the one or more advertising content servers, the one or more advertisements selected by the one or more advertising content servers using the selected keywords; and
providing, by the one or more processors, the advertisements to the user during the conversation.

2. The method of claim 1, further comprising:
integrating the advertisements into responses from the chatbot.

3. The method of claim 1, wherein the advertisements are selected further using a predicted click-through rate for the user.

4. The method of claim 1, wherein the machine learning model is trained on data comprising translations of labeled examples from a first language into a second language.

5. The method of claim 1, further comprising:
accessing, by the one or more processors, a long-term memory of the user's conversations to provide contextual information for assigning the commercial scores.

6. The method of claim 1, further comprising:
accessing, by the one or more processors, user profile data to provide contextual information for assigning the commercial scores.

7. The method of claim 1, wherein the conversation comprises a group chat, and wherein the method further comprises:
analyzing, by the one or more processors, messages from multiple users in the group chat.

8. A machine, comprising:
one or more processors; and
a memory storing instructions that, when executed by the one or more processors, cause the machine to perform operations comprising:
detecting a commercial intent during a conversation between a user and a chatbot; and
in response to detecting the commercial intent, performing operations comprising:
extracting keyword candidates from the conversation;
assigning a relevance score to each keyword candidate using a meaning of the conversation;
assigning a commercial score to each keyword candidate using a machine learning model trained to detect commercially related keywords;
selecting keywords using a combination of the relevance scores and commercial scores;
transmitting the selected keywords to one or more advertising content servers;
receiving one or more advertisements from the one or more advertising content servers, the one or more advertisements selected by the one or more advertising content servers using the selected keywords; and
providing the advertisements to the user during the conversation.

9. The machine of claim 8, wherein the operations further comprise:
integrating the advertisements into responses from the chatbot.

10. The machine of claim 8, wherein the advertisements are selected further using a predicted click-through rate for the user.

11. The machine of claim 8, wherein the machine learning model is trained on data comprising translations of labeled examples from a first language into a second language.

12. The machine of claim 8, wherein the operations further comprise:
accessing a long-term memory of the user's conversations to provide contextual information for assigning the commercial scores.

13. The machine of claim 8, wherein the operations further comprise:
accessing user profile data to provide contextual information for assigning the commercial scores.

14. The machine of claim 8, wherein the conversation comprises a group chat, and wherein the operations further comprise:
analyzing messages from multiple users in the group chat.

15. A computer-readable medium storing instructions that, when executed by one or more processors of a computer, cause the computer to perform operations comprising:
detecting a commercial intent during a conversation between a user and a chatbot; and
in response to detecting the commercial intent, performing operations comprising:
extracting keyword candidates from the conversation;
assigning a relevance score to each keyword candidate using a meaning of the conversation;
assigning a commercial score to each keyword candidate using a machine learning model trained to detect commercially related keywords;
selecting keywords using a combination of the relevance scores and commercial scores;
transmitting the selected keywords to one or more advertising content servers;
receiving one or more advertisements from the one or more advertising content servers, the one or more advertisements selected by the one or more advertising content servers using the selected keywords; and
providing the advertisements to the user during the conversation.

16. The computer-readable medium of claim 15, wherein the operations further comprise:
integrating the advertisements into responses from the chatbot.

17. The computer-readable medium of claim 15, wherein the advertisements are selected further using a predicted click-through rate for the user.

18. The computer-readable medium of claim 15, wherein the operations further comprise:
accessing a long-term memory of the user's conversations to provide contextual information for assigning the commercial scores.

19. The computer-readable medium of claim 15, wherein the operations further comprise:
accessing user profile data to provide contextual information for assigning the commercial scores.

20. The computer-readable medium of claim 15, wherein the conversation comprises a group chat, and wherein the operations further comprise:
analyzing messages from multiple users in the group chat.
